(19) United States
(12) Patent Application Publication
(10) Pub. No.: US 2025/0256590 A1
(43) Pub. Date: Aug. 14, 2025

(54) RAIL-RUNG SYSTEM FOR INSTALLATION OF A 3-PHASE DYNAMIC WIRELESS POWER TRANSFER TRANSMITTER IN A ROADWAY

(71) Applicant: Purdue Research Foundation, West Lafayette, IN (US)

(72) Inventors: Aaron Dean Brovont, West Lafayette, IN (US); Robert R. Swanson, Lafayette, IN (US); Steven D. Pekarek, West Lafayette, IN (US); Dionysios Aliprantis, West Lafayette, IN (US)

(73) Assignee: Purdue Research Foundation, West Lafayette, IN (US)

(21) Appl. No.: 19/046,408

(22) Filed: Feb. 5, 2025

Related U.S. Application Data
(60) Provisional application No. 63/553,057, filed on Feb. 13, 2024.

(51) Int. Cl. B60L 53/122; H02J 50/00; H02J 50/10

(52) U.S. Cl. CPC B60L 53/122; H02J 50/005; H02J 50/10

(57) ABSTRACT

A form for a three-phase dynamic wireless power transfer (DWPT) in-ground system, includes a plurality of rungs each coupled to a plurality of rails, each rung including a plurality of cable coupling arrangements each adapted to receive a cable, a pattern plate including a plurality of holes each adapted to receive a cable of the DWPT in ground system, and three elongated cables each having an endturn and each coupled to the plurality of rungs at a plurality of cable coupling arrangements, each end of each of the three elongated cables configured to pass through an associated hole of the plurality of holes in the pattern plate.

### CROSS-REFERENCE TO RELATED APPLICATIONS

The present non-provisional patent application is related to and claims the priority benefit of U.S. Provisional Patent Application Ser. 63/553,057, filed Feb. 13, 2024, the contents of which are hereby incorporated by reference in its entirety into the present disclosure.

### STATEMENT REGARDING GOVERNMENT FUNDING

This invention was made with government support under grant 1941524, awarded by the National Science Foundation. The government has certain rights in the invention.

### TECHNICAL FIELD

The present disclosure generally relates to wireless power transfer and in particular to a rail-rung system for installation of a 3-phase dynamic wireless power transfer transmitter in a roadway for electric vehicles.

### BACKGROUND

This section introduces aspects that may help facilitate a better understanding of the disclosure. Accordingly, these statements are to be read in this light and are not to be understood as admissions about what is or is not prior art.

Electric vehicles are becoming ubiquitous in the vehicular transportation regime, whether for transporting humans or cargo. However, the charging infrastructure is lagging. In particular, while wired charging stations are continuously added, these wired charging stations are few and far between to accommodate the growing demand for electric vehicles. In concert with adding new wired charging stations, there has been an effort to incorporate dynamic wireless power transfer (DWPT) coils into roadways.

DWPT systems are being considered as a means to provide the power to move, operate, and maintain or increase the state-of-charge of batteries in electric vehicles. DWPT systems utilize transmitter (tx) coils embedded within the roadway to establish time-changing magnetic fields above the road surface. These time-changing magnetic fields induce a voltage in receiver (rx) coils that are incorporated in an underside compartment of an electric vehicle as the vehicle passes over an energized transmitter. The induced voltage is then used to provide power to vehicle subsystems, including propulsion and energy storage (battery).

However, many challenges remain in facilitating DWPT coils in a roadway. One such challenge is that performance is sensitive to the location of the individual phase windings relative to the base roadway layer and to one another. Maintaining a desired tolerance becomes challenging given road construction variables, where roadway material is poured over the tx. Also, the windings are made of wires, e.g., Litz wire, which has sufficient elasticity to prevent the coils from maintaining a precise shape after forming. Finally, at the end-winding locations, managing the overlap of windings is necessary to minimize the profile of the tx to ensure there is sufficient road material to maintain roadway integrity based on the volume occupied by the overlapping end-turn sections of the tx.

Therefore, there is an unmet need for a novel system and method of incorporating three-phase transmitter coils in the roadways to be coupled with the receiver coils in a vehicle employing compatible construction techniques.

### SUMMARY

A form for a three-phase dynamic wireless power transfer (DWPT) in-ground system, includes a plurality of rungs each coupled to a plurality of rails, each rung including a plurality of cable coupling arrangements each adapted to receive a cable, a pattern plate including a plurality of holes each adapted to receive a cable of the DWPT in ground system, and three elongated cables each having an endturn and each coupled to the plurality of rungs at a plurality of cable coupling arrangements, each end of each of the three elongated cables configured to pass through an associated hole of the plurality of holes in the pattern plate.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is an example schematic of a dynamic wireless power transfer (DWPT) system in which a vehicle is shown with three coils each associated with a charging phase denoted as small letters a, b, and c, and three charging coils in the ground each associated with a corresponding charging phase denoted as capital letters A, B, and C.

FIG. 2 is a schematic of the coils in the road so as to depict the configuration of the transmitter coils in the DWPT system.

FIG. 3 is a photograph of a DWPT system installation system that includes a nonmetallic rigid ladder structure referred to as ‘rungs’ and ‘rails’, according to the present disclosure.

FIG. 4 is a schematic of the disposition of the 3-phase coils as well as the rung and rails, wherein the rungs and the coils coupled thereto are assembled offsite and unrolled in a ground pocket.

FIG. 5 is a detailed schematic view of the pattern plate and the routing of the transmitter cables through the pattern plate into the center stub-out.

FIG. 6 is a perspective view of the cables shown at an end-turn, along with a side view of two rails and one of the plurality of rungs as well as the holes in the rung to maintain position of the cables.

FIG. 7 is a sideview of the rung and rail assembly along with the pattern plate and twisted cables out of the pattern plate.

FIG. 8 is a cross sectional view of the cables through the pattern plate.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

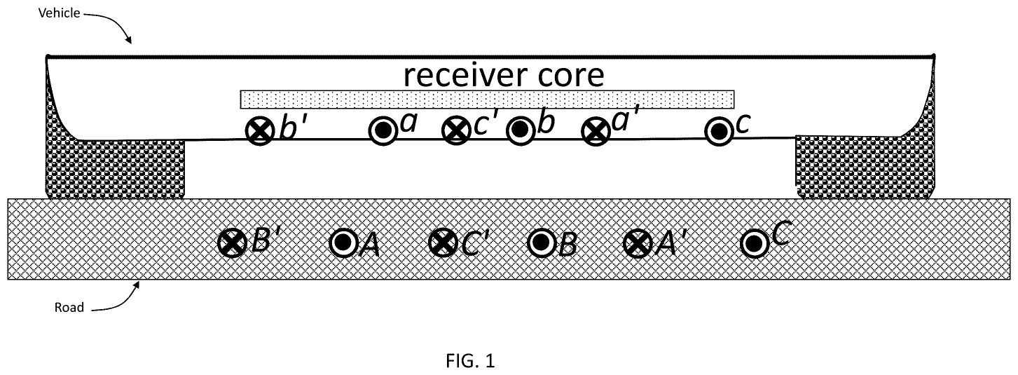

A novel system and method are disclosed for incorporating three-phase transmitter coils in the roadways to be coupled with the receiver coils in a vehicle employing compatible roadway construction techniques. Towards this end, a rail-rung system is disclosed which can be utilized to maintain position of the three coils in a compact, low-volume setup. Referring to FIG. 1, an example of a dynamic wireless power transfer (DWPT) system is provided in which a vehicle is shown with three coils each associated with a charging phase denoted as small letters a, b, and c, and three charging coils in the ground each associated with a corresponding charging phase denoted as capital letters A, B, and C. The DWPT system shown in FIG. 1 is based on a transverse moving flux topology thus allowing a moving vehicle to generate charge for propulsion or battery charging. In FIG. 1, each circle denotes a conductor wire as part of a corresponding coil, with a dot within a circle representing current defined as positive coming out of the page and a cross within a circle denoting current defined as positive going into the page. It should be noted that the aforementioned directionality is only a convention based on the assumption of what positive current signifies. Thus, the coils in the roadway need not be disposed in the same manner as the coils in the vehicle. In the non-limiting embodiment of FIG. 1, the placement of the transmitter coils in the road as well as the placement of receiver coils in the vehicle are mirror images of each other with respect to a central vertical line (not shown). Therefore, if the dot side of coil C (i.e., the farthest coil (coil C)) is x_{c} away from the centerline (not shown), then cross side of coil B (i.e., the nearest coil (coil B)) is also x_{c} away from the centerline (not shown) on the opposite side of the centerline (not shown). Similarly, if the dot side of Coil A is −x_{A}· away from one side of the centerline (not shown), the cross side of coil A is the same x_{A}· away from the centerline (not shown) on the opposite side of the centerline. Finally, if the dot side of coil B is x_{B} away from the centerline (not shown) on one side of the centerline (not shown), then the cross side of coil C is also x_{B} away from the centerline (not shown) on opposite side of the centerline (not shown). The same mirror image configuration also holds true for receiver coils.

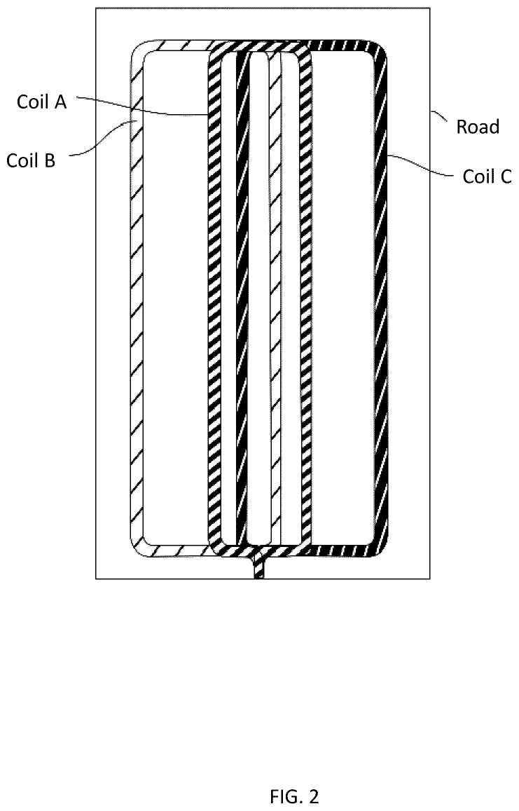

Referring to FIG. 2, another view of the coils in the road are shown so as to depict the configuration of the transmitter coils. In FIG. 2, the three transmitter coils are shown in the same mirror image manner with respect to a vertical centerline (not shown) as discussed above with reference to FIG. 1.

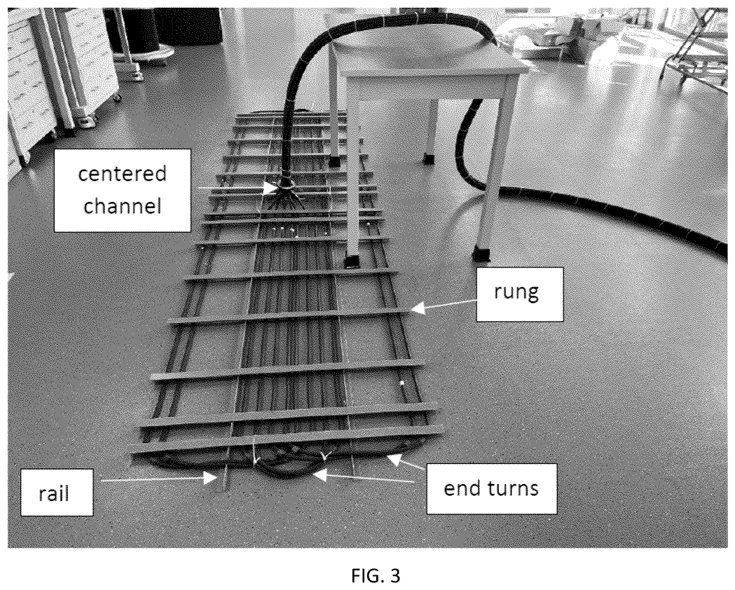

To meet these challenges, an installation system is disclosed herein that includes a nonmetallic rigid ladder structure referred to as ‘rungs’ and ‘rails’ as provided in FIG. 3. The rungs, which in one non-limiting embodiment are shorter L-shaped members include holes to enable threading of conductors. Alternatively, the rungs may include grooves in which the conductors are positioned or pressed in for a secure placement. In a non-limiting embodiment, the rungs also have grooves on a top side to interface with the rails. The rails, which in a non-limiting embodiments are also L-shaped, are grooved to be placed within associated rung grooves to thereby position and tension the conductors. The length of the rungs and rails can be adjusted to enable precise positioning in roadway channels. A photograph of the structure is shown in FIG. 3.

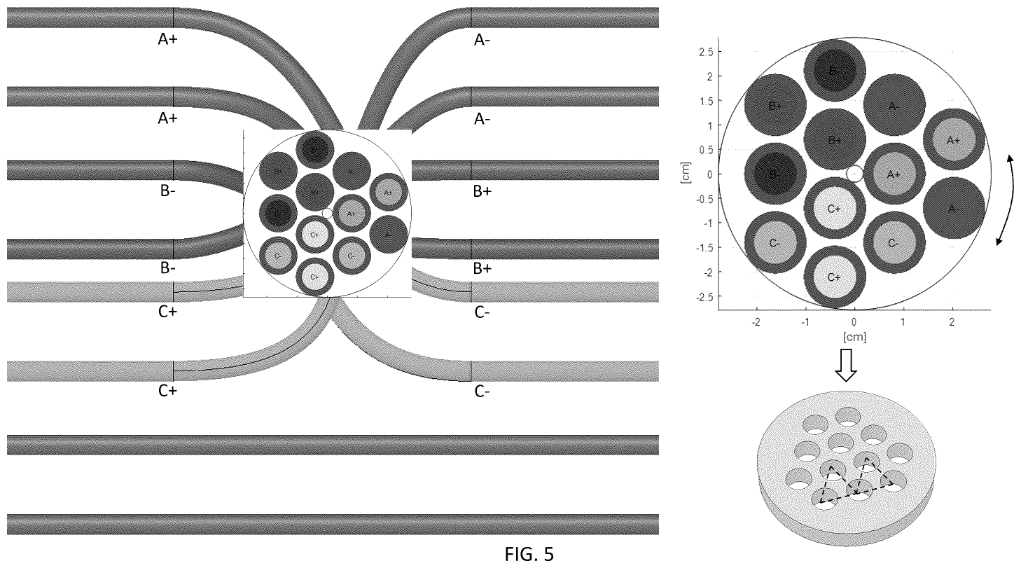

The rail and rung system shown in FIG. 3 is compatible with current highway construction approaches while providing exact and repeatable placement of coil conductors. As shown, the rung and rail system includes a plurality of rungs that engage a plurality of rails. The cables of the 3-phase coils run through the rungs according to one embodiment. The cables come out of the system as shown in a centered channel through a pattern plate more clearly shown in FIG. 5. It should be noted that the rung and rail system shown in FIG. 3 is upside down. That is, in operation the pattern plate and the centered channel face downward into the ground, but these structures are shown upside down for added clarity in FIG. 3.

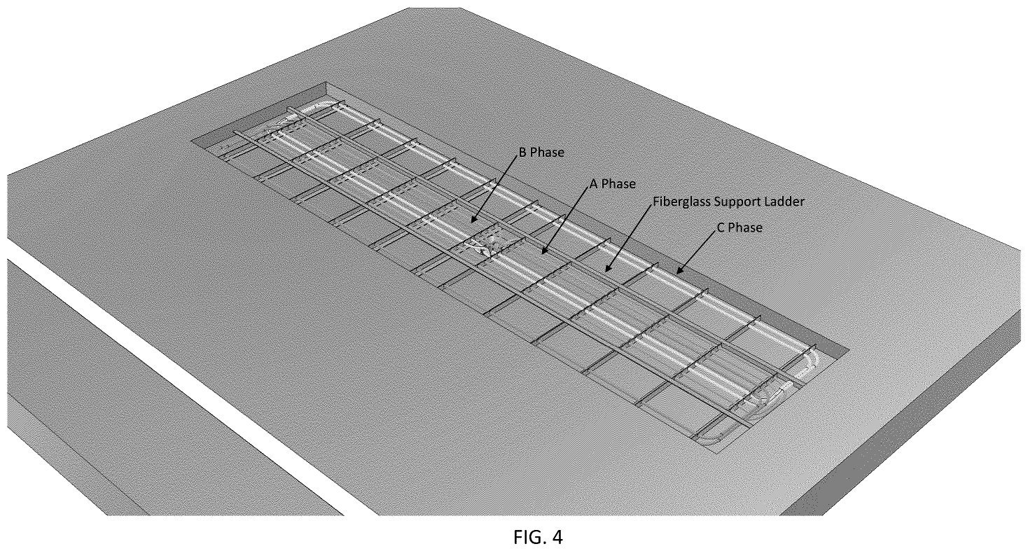

Referring to FIG. 4, the disposition of the 3-phase coils as well as the rung and rails are further depicted. According to the embodiment of FIG. 4, the rungs and the coils coupled thereto are assembled offsite and unrolled in a ground pocket. Next, the rails are installed onto the rungs after the coils and rungs are arranged in the ground pocket. The legend of FIG. 4 provides the color-coding for the three phases: A-phase is shown as blue, B-phase is shown as red, and C-phase is shown as yellow. The rung and rails are shown as fiberglass.

An example of the ground pocket dimension is about 148 inches long by about 40 inches wide by about 3.5 inches deep. An example of the coil dimensions is about 144 inches long by about 36 inches wide. The rung and rail system have, e.g., about ¼ inches clearance to pocket on all sides to aid in positioning of the transmitter coils in the ground pocket. As shown in FIG. 4, cables exit through a center stub-out.

Referring to FIG. 5, a detailed view is shown of the pattern plate and the routing of the transmitter cables through the pattern plate into the center stub-out. The stub-out represents a 4 inches conduit containing, e.g., 12 4-AWG wires. The pattern plate which provides a specific pattern for the cable provides: 1) Align cable for proper exit order; 2) plugs conduit to mitigate concrete leakage, and 3) minimizes inductance of transmitter leads. As shown two sets of coil leads are accommodated by the pattern plate, one set from each side of the pattern plate.

The pattern plate shown in FIG. 5 represents a minimal sizing. To achieve this minimum sizing, the holes in the pattern plate are arranged so that center of each hole coincides one or more equilateral triangle vertices with the triangles' dimensions such that a minimum predetermined material is observed between the holes based on consideration of application, material, and longevity requirements. In FIG. 5, two such equilateral triangles are shown.

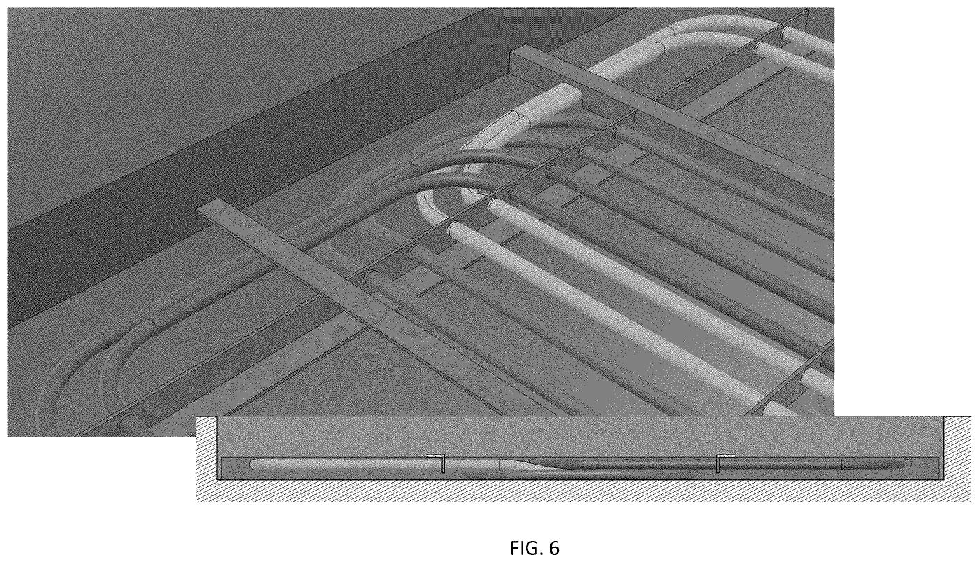

Referring to FIG. 6, a perspective view of the cables are shown at an end-turn, along with a side view of two rails and one of the plurality of rungs as well as the holes in the rung to maintain position of the cables. Additionally, rails have notches to help constrain end-turns to remain flush/subflush of TX coil.

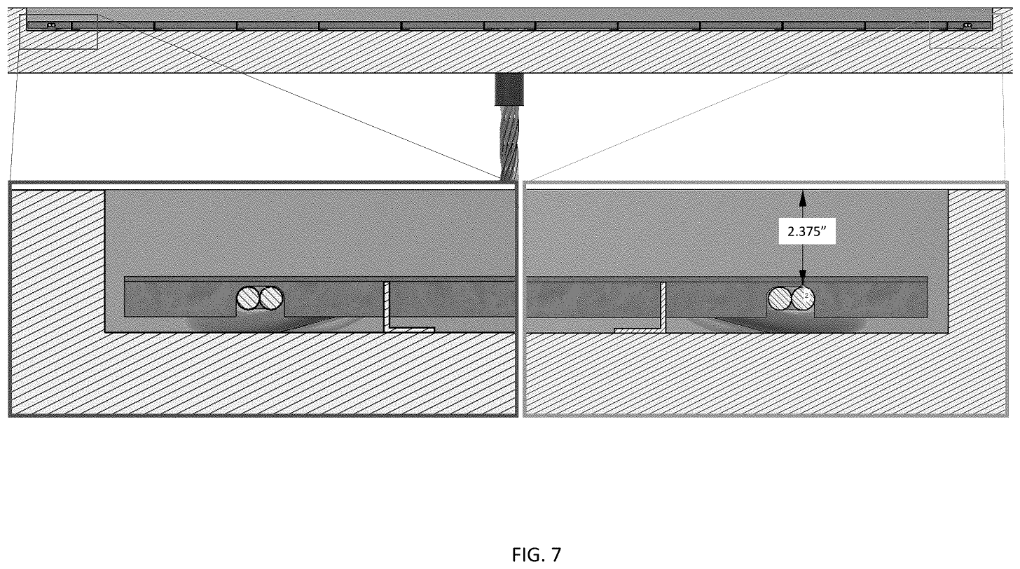

Referring to FIG. 7, a sideview of the rung and rail assembly along with the pattern plate and twisted cables out of the pattern plate. Side portions of the system are shown as magnified panels to illustrate rail support interlock and rail endturn restraints. Accordingly, end turns restricted to two wire diameters thick. According to one embodiment, nominal distance from top of wire to top of roadway is, e.g., 2.375 inches.

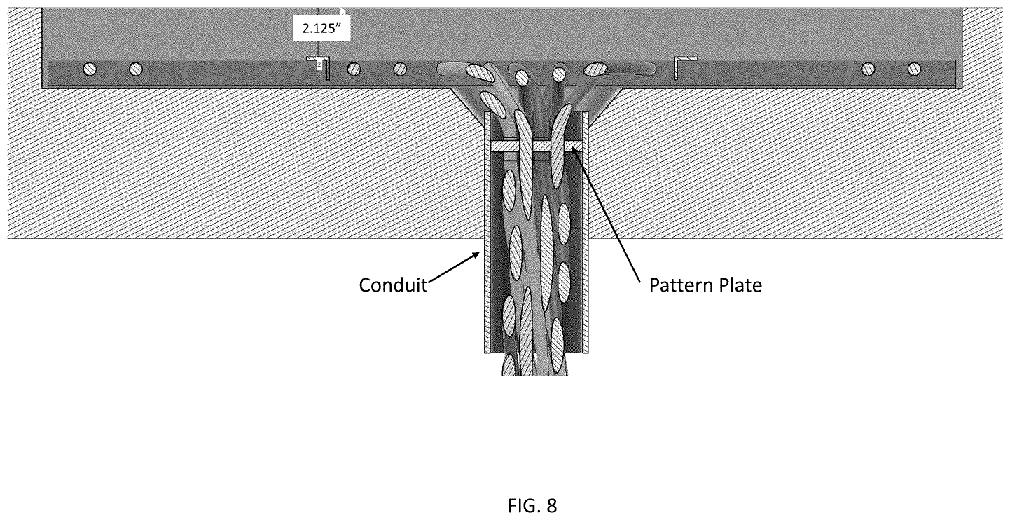

Referring to FIG. 8, a cross sectional view of the cables through the pattern plate is shown. A conduit is also shown protecting the cables. According to one embodiment, the nominal distance from top of rung and rail assembly to top of roadway is, e.g., 2.125 inches.

It should be further noted that all dimensions provided herein are for illustrative purposes. Thus, no limitations should be attached to the present disclosure based on these dimensions. In operation, the dimensions discussed herein can be varied to accommodate different roadway configurations.

It should also be noted that the rung and rail system of the present disclosure can be used in roadways intended to provide electrical charge to a moving vehicle or be placed at a charging station or at a cross-section for charging a stationary vehicle.

Additionally, it should be noted that the rung and rail system disclosed herein is intended to maintain the coil conductors under tension in order to maintain position of the coil conductors.

Those having ordinary skill in the art will recognize that numerous modifications can be made to the specific implementations described above. The implementations should not be limited to the particular limitations described. Other implementations may be possible.

1. A form for a three-phase dynamic wireless power transfer (DWPT) in-ground system, comprising:
a plurality of rungs each coupled to a plurality of rails, each rung including a plurality of cable coupling arrangements each adapted to receive a cable;
a pattern plate including a plurality of holes each adapted to receive a cable of the DWPT in ground system; and
three elongated cables each having an endturn and each coupled to the plurality of rungs at a plurality of cable coupling arrangements, each end of each of the three elongated cables configured to pass through an associated hole of the plurality of holes in the pattern plate.

2. The form of claim 1, wherein the plurality of holes in the pattern plate include 12 holes for two sets of forms.

3. The form of claim 1, wherein the rails include notches to maintain position of the endturns of the three elongated cables.

4. The form of claim 1, wherein one or more of the plurality of rungs is L-shaped.

5. The form of claim 1, wherein one or more of the plurality of rails is L-shaped.

6. The form of claim 1, wherein each of the plurality of cable coupling arrangements in each of the plurality of rungs is a hole in said rung.

7. The form of claim 1, wherein each of the plurality of cable coupling arrangements in each of the plurality of rungs is a notch in said rung.

8. The form of claim 1, wherein each of the plurality of rungs is made of a non-electrically conducting material.

9. The form of claim 8, wherein the non-electrically conducting material is fiberglass.

10. The form of claim 1, wherein each of the plurality of rails is made of a non-electrically conducting material.

11. The form of claim 10, wherein the non-electrically conducting material is fiberglass.

12. The form of claim 1, wherein the form is disposed in a roadway and is configured to provide charge to a moving vehicle.

13. The form of claim 1, wherein the form is disposed at a stationary location and is configured to provide charge to a stationary vehicle.

14. The form of claim 1, wherein the plurality of rungs and the plurality of rails are configured to place each of the three elongated cables in a predetermined amount of tension.

15. The form of claim 1, wherein the plurality of holes in the pattern plate are arranged such that center of each hole coincides with a vertex of one or more equilateral triangles.

16. The form of claim 15, wherein each side of the one or more equilateral triangles is sized so that a predetermined amount of material is observed between each neighboring holes.

17. The form of claim 16, wherein the predetermined amount of material is based on predetermined requirements including material selection of the pattern plate, longevity, and application of the form.
